(19) United States
(12) Patent Application Publication
(10) Pub. No.: US 2023/0367430 A1
(43) Pub. Date: Nov. 16, 2023

(54) INFORMATION PROCESSING APPARATUS AND INFORMATION PROCESSING METHOD

(71) Applicant: SONY SEMICONDUCTOR SOLUTIONS CORPORATION, KANAGAWA (JP)

(72) Inventors: TAKAFUMI ASAHARA, KANAGAWA (JP); GOSHI WATANABE, KANAGAWA (JP); TAKAKI UENO, KANAGAWA (JP); KAZUYUKI OKUIKE, KANAGAWA (JP); SATOMI KAWASE, KANAGAWA (JP); SUGURU KOBAYASHI, KANAGAWA (JP); NORIBUMI SHIBAYAMA; HIROTAKA NIIKURA, KANAGAWA (JP); JUNYA MIZUTANI, KANAGAWA (JP); TOSHIHISA MIYAKE, KANAGAWA (JP)

(21) Appl. No.: 18/247,743

(22) PCT Filed: Aug. 13, 2021
(86) PCT No.: PCT/JP2021/029815

§ 371 Date: Apr. 3, 2023

(30) Foreign Application Priority Data
Oct. 9, 2020 (JP) 2020-171515

(51) Int. Cl. G06F 3/042

(52) U.S. Cl. CPC G06F 3/0426

(57) ABSTRACT

Provided is an information processing apparatus capable of further improving operability. A virtual touch panel surface that does not actually exist is set in a space in front of a display surface of a display. Then, a touch operation on the virtual touch panel surface performed by a user is detected on the basis of position information of a specific site of a body used by the user for the touch operation on the virtual touch panel surface, and processing corresponding to the detected touch operation is executed. Here, in the setting of the virtual touch panel surface, a curvature radius of a movement trajectory of the specific site when the user has moved the specific site in a predetermined direction is calculated on the basis of the position information of the specific site, and a flat surface is set as the virtual touch panel surface in a case where it is determined that the calculated curvature radius is larger than a predetermined threshold, and a curved surface whose central portion is recessed to a side of the display is set as the virtual touch panel surface in a case where it is determined that the curvature radius calculated by a calculation unit is equal to or smaller than the predetermined threshold.

### TECHNICAL FIELD

The present disclosure relates to an information processing apparatus and an information processing method.

### BACKGROUND ART

Conventionally, an information processing apparatus having a non-contact user interface configured to perform an input operation on a computing device is proposed (see, for example, Patent Document 1). In the information processing apparatus described in Patent Document 1, a virtual touch panel surface that does not actually exist is set to perform the input operation via the virtual touch panel surface in order to improve operability.

### CITATION LIST

### Patent Document

Patent Document 1: Japanese Patent Application Laid-Open No. 2016-134022

### SUMMARY OF THE INVENTION

### Problems to be Solved by the Invention

In such an information processing apparatus, further improvement in operability is required.

An object of the present disclosure is to provide an information processing apparatus and an information processing method capable of further improving operability.

### Solutions to Problems

An information processing apparatus according to the present disclosure includes: (a) a virtual touch panel surface setting unit that sets a virtual touch panel surface, which does not actually exist, in a space in front of a display surface of a display; (b) an operation detection unit that detects a touch operation on the virtual touch panel surface performed by a user on the basis of position information of a specific site of a body used by the user for the touch operation on the virtual touch panel surface; and (c) a processing execution unit that executes processing corresponding to the touch operation detected by the operation detection unit, and the virtual touch panel surface setting unit includes (d) a calculation unit that calculates a curvature radius of a movement trajectory of the specific site when the user has moved the specific site in a predetermined direction on the basis of the position information of the specific site, and (e) a setting execution unit that sets a flat surface as the virtual touch panel surface in a case where it is determined that the curvature radius calculated by the calculation unit is larger than a predetermined threshold, and sets a curved surface whose central portion is recessed to a side of the display as the virtual touch panel surface in a case where it is determined that the curvature radius calculated by the calculation unit is equal to or smaller than the predetermined threshold.

Furthermore, an information processing method of the present disclosure includes: (a) setting a virtual touch panel surface, which does not actually exist, in a space in front of a display surface of a display; (b) detecting a touch operation on the virtual touch panel surface performed by a user on the basis of position information of a specific site of a body used by the user for the touch operation on the virtual touch panel surface; and (c) executing processing corresponding to the detected touch operation, and the setting of the virtual touch panel surface includes (d) calculating a curvature radius of a movement trajectory of the specific site when the user has moved the specific site in a predetermined direction on the basis of the position information of the specific site, and (e) setting a flat surface as the virtual touch panel surface in a case where it is determined that the calculated curvature radius is larger than a predetermined threshold, and setting a curved surface whose central portion is recessed to a side of the display as the virtual touch panel surface in a case where it is determined that the calculated curvature radius is equal to or smaller than the predetermined threshold.

### BRIEF DESCRIPTION OF DRAWINGS

FIG. 1 is a diagram illustrating an overall configuration of an information processing apparatus according to a first embodiment, the diagram illustrating a case where a virtual touch panel surface is a flat surface.

FIG. 2 is a diagram illustrating the overall configuration of the information processing apparatus according to the first embodiment, the diagram illustrating a case where the virtual touch panel surface is a curved surface.

FIG. 3 is a diagram illustrating a calibration unit, a virtual touch panel surface construction unit, a gesture recognition unit, and a display surface construction unit achieved by a processor.

FIG. 4 is a diagram illustrating a flowchart of a calibration process.

FIG. 5 is a diagram illustrating a target trajectory displayed on a display surface of a display.

FIG. 6 is a diagram illustrating a method of calculating a curvature radius of a movement trajectory of a specific site, the diagram illustrating a case where a flat surface is set as the virtual touch panel surface.

FIG. 7 is a diagram illustrating the method of calculating a curvature radius of a movement trajectory of a specific site, the diagram illustrating a case where a curved surface is set as the virtual touch panel surface.

FIG. 8 is a flowchart of an ordering process.

FIG. 9 is a diagram illustrating operation of an operation detection unit in the information processing apparatus.

FIG. 10 is a diagram illustrating operation of an operation detection unit in an information processing apparatus according to a modified example.

FIG. 11 is a diagram illustrating a virtual touch panel surface in the information processing apparatus according to the modified example.

FIG. 12 is a diagram illustrating a virtual touch panel surface in the information processing apparatus according to the modified example.

FIG. 13 is a diagram illustrating a calibration unit, a virtual touch panel surface construction unit, a gesture recognition unit, and a display surface construction unit achieved by a processor of an information processing apparatus according to a second embodiment.

FIG. 14 is a diagram illustrating a flowchart of a calibration process.

FIG. 15 is a flowchart of an ordering process.

FIG. 16 is a diagram illustrating a method of calculating a curvature radius of a movement trajectory of a specific site, the diagram illustrating a case where a flat surface is set as a virtual touch panel surface.

FIG. 17 is a diagram illustrating a method of calculating a curvature radius of a movement trajectory of a specific site, the diagram illustrating a case where a curved surface is set as the virtual touch panel surface.

FIG. 18 is a diagram illustrating operation of an operation detection unit in an information processing apparatus according to a modified example.

### MODE FOR CARRYING OUT THE INVENTION

The present inventors have considered an information processing apparatus having a virtual touch panel surface that employs a configuration in which the virtual touch panel surface, for example, having a vertical planar shape is set on a side of a display with respect to a movement trajectory of a fingertip of a user at the time of execution of calibration such that an input operation on a display surface of the display can be performed by a touch operation on the virtual touch panel surface. However, as a result of further research on such an information processing apparatus, it has been found that a distance between the fingertip and the virtual touch panel surface increases on a side of an end portion of the virtual touch panel surface in a case where the user moves the fingertip so as to draw an arc-shaped movement trajectory about a shoulder and an elbow. Then, the present inventors have found that a distance for pushing the fingertip becomes long when the touch operation is performed on the virtual touch panel surface so that operability deteriorates.

Hereinafter, embodiments of an information processing apparatus and an information processing method of the present disclosure will be described with reference to the drawings.

However, the embodiments to be described hereinafter are merely examples, and are not intended to exclude various modifications and applications of technologies that are not explicitly described below. The present disclosure can be variously modified and implemented within a range not departing from the gist thereof. For example, the respective embodiments may be implemented in combination.

Furthermore, the same or similar portions are denoted by the same or similar reference signs in the following drawings. Furthermore, the drawings are schematic, and do not necessarily coincide with actual dimensions, ratios, and the like. Furthermore, the drawings may also include portions having mutually different dimensional relationships and ratios.

Furthermore, effects described in the present specification are merely examples and are not limited, and there may be other effects.
1. First Embodiment: Information Processing Apparatus and Information Processing Method
   1-1 Overall Configuration of Information Processing Apparatus
   1-2 Contents of Calibration Process
   1-3 Contents of Ordering Process
   1-4 Modified Examples
2. Second Embodiment: Information Processing Apparatus and Information Processing Method
   2-1 Configuration of Main Part
   2-2 Modified Examples

### 1. FIRST EMBODIMENT

### 1-1 Overall Configuration of Information Processing Apparatus

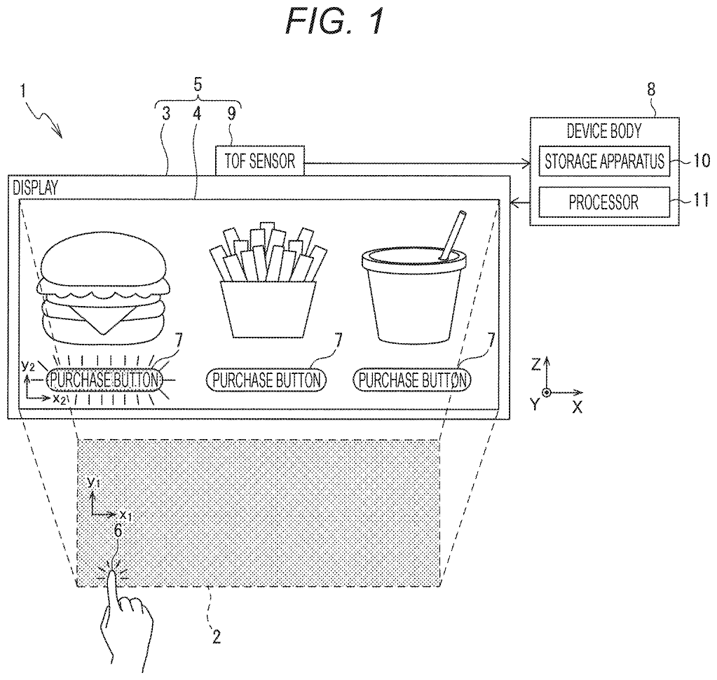

FIG. 1 is a diagram illustrating an overall configuration of an information processing apparatus 1 according to a first embodiment. The information processing apparatus 1 in FIG. 1 is a computing device including a user interface 5 that allows a user to perform an input operation on a display surface 4 of a display 3 without touching the display surface 4 by a touch operation on a virtual touch panel surface 2 that does not actually exist. The virtual touch panel surface 2 is a virtual touch panel surface set in a space in front of the display surface 4 of the display 3.

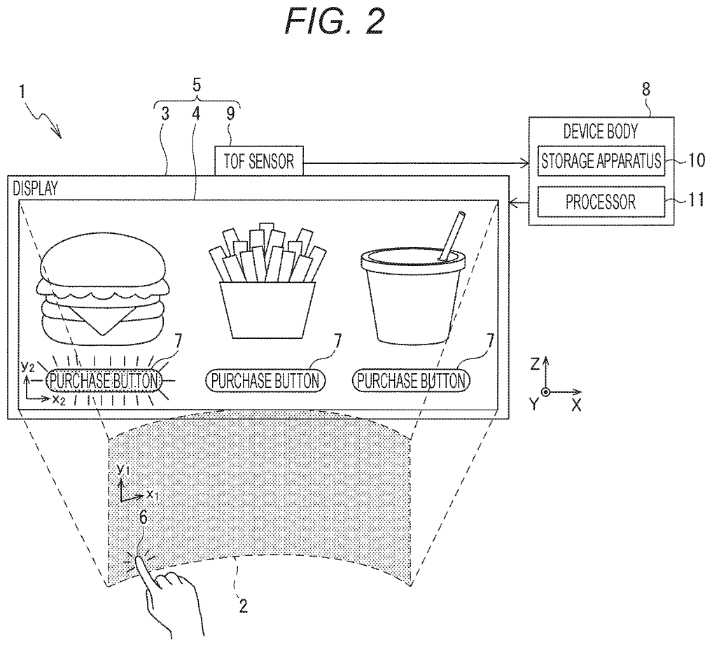

FIG. 1 exemplifies a case where an ordering apparatus is configured as the information processing apparatus 1, the ordering apparatus being installed in a drive-through fast food store and allowing a purchaser (user) visiting the store in a vehicle to press and operate purchase buttons 7 of products including a hamburger, fried potatoes, a drink, and the like by extending a specific site 6 of a body from the inside of the vehicle and performing a touch operation to touch the virtual touch panel surface 2 with the specific site 6. The specific site 6 is only required to be, for example, any site that can be used by the user for the touch operation on the virtual touch panel surface 2. FIG. 1 illustrates a case where a fingertip is adopted as the specific site 6. Note that FIG. 1 illustrates a case where a flat surface is set as the virtual touch panel surface 2, but a curved surface (for example, an arc-shaped cylindrical surface) can also be set as illustrated in FIG. 2.

As illustrated in FIG. 1, the information processing apparatus 1 includes the user interface 5 and a computing device body (hereinafter, also referred to as “device body 8”).

The user interface 5 includes the display 3 and an information acquisition unit 9. As the display 3, for example, a liquid crystal display, an organic electro-luminescence (EL) display, or a projector can be adopted. Furthermore, as the information acquisition unit 9, for example, a time of flight (TOF) sensor that captures a distance image in front of the display surface 4 of the display 3, a stereo camera that captures a stereo image in front of the display surface 4 of the display 3, and an ultrasonic sensor that measures a time until an ultrasonic wave is emitted in front of the display surface 4 and a reflected wave thereof returns can be adopted.

The display 3 displays various images on the display surface 4 according to a command from the device body 8. FIG. 1 illustrates a case where a shape of the display surface 4 is a vertical rectangular planar shape.

The information acquisition unit 9 is arranged in an upper part of the display 3, and acquires information regarding a position of an object present in front of the display surface 4 of the display 3. A detection result of the information acquisition unit 9 is output to the device body 8. FIG. 1 illustrates a case where the TOF sensor is used as the information acquisition unit 9. Furthermore, the “information acquisition unit 9” is also referred to as the “TOF sensor 9” in the following description.

The device body 8 includes hardware resources including a storage apparatus 10, a processor 11, and the like. As the storage apparatus 10, for example, an auxiliary storage apparatus including a memory such as a hard disk drive or a solid state drive can be adopted. Furthermore, as the processor 11, for example, various processors such as a CPU, a GPU, an ASIC, and an FPGA can be adopted.

The storage apparatus 10 stores a control program of the information processing apparatus 1 executable by the processor 11. Furthermore, the storage apparatus 10 stores various types of data necessary for executing the control program.

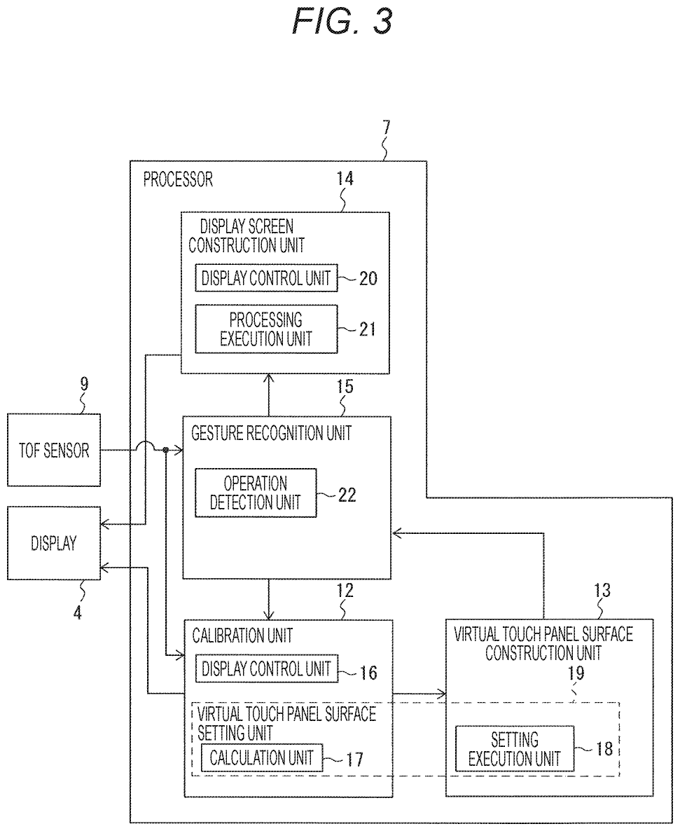

The processor 11 achieves a calibration unit 12, a virtual touch panel surface construction unit 13, a gesture recognition unit 15, and a display surface construction unit 14 as illustrated in FIG. 3 according to the control program stored in the storage apparatus 10. The calibration unit 12 includes a display control unit 16 and a calculation unit 17. Furthermore, the virtual touch panel surface construction unit 13 includes a setting execution unit 18. Furthermore, the calculation unit 17 and the setting execution unit 18 constitute a virtual touch panel surface setting unit 19. Furthermore, the display surface construction unit 14 includes a display control unit 20 and a processing execution unit 21. Furthermore, the gesture recognition unit 15 includes an operation detection unit 22. Then, the display control unit 16, the calculation unit 17, and the setting execution unit 18 execute a calibration process for setting the virtual touch panel surface 2 on the basis of the detection result of the TOF sensor 9. Furthermore, the operation detection unit 22 and the processing execution unit 21 execute an ordering process in which the purchase button 7 and the like displayed on the display surface 4 can be pressed by the set touch operation on the virtual touch panel surface 2 on the basis of the detection result of the TOF sensor 9.

### 1-2 Content of Calibration Process

Next, the calibration process executed by the display control unit 16, the calculation unit 17, and the setting execution unit 18, which are achieved by the processor 11, will be described. The calibration process is executed each time a user (fast food purchaser) of the information processing apparatus 1 changes. Furthermore, the calibration process is also executed during the ordering process in a case where an erroneous touch operation frequently occurs during the ordering process.

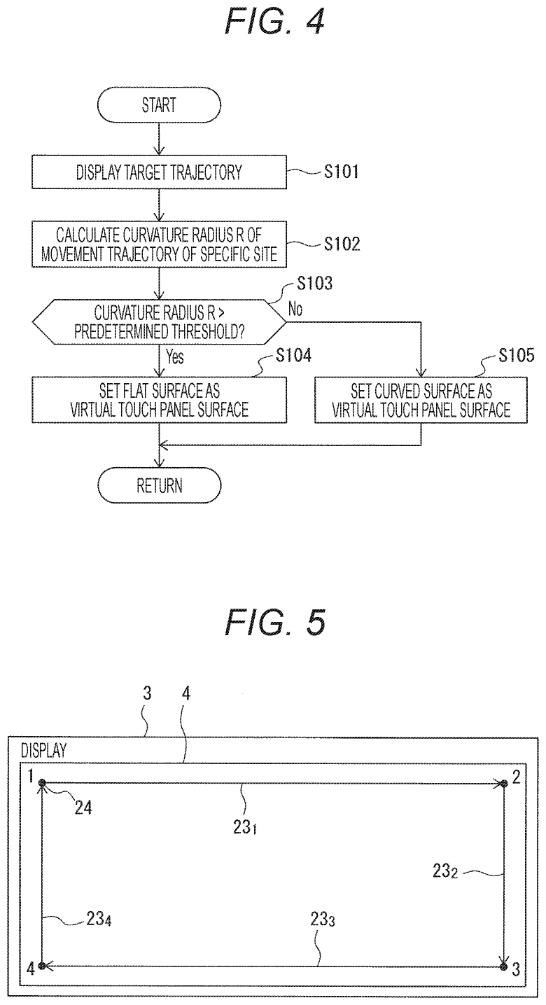

As illustrated in FIG. 4, in step S101, the display control unit 16 first displays a target trajectory including a straight line extending in a predetermined direction on the display surface 4 of the display 3. For example, as illustrated in FIG. 5, a rectangle including an arrow-shaped straight line 23₁ extending from an upper left corner to an upper right corner of the display surface 4, a straight line 23₂ extending from the upper right corner to a lower right corner, a straight line 23₃ extending from the lower right corner to a lower left corner, and a straight line 23₄ extending from the lower left corner to the upper left corner is set as the target trajectory. Furthermore, in the first embodiment, the lateral direction is referred to as a “predetermined direction”, and the straight lines 23₁ and 23₃ extending in the lateral direction among the straight lines 23₁, 23₂, 23₃, and 23₄ are referred to as “straight lines extending in the predetermined direction”. Furthermore, the straight lines 23₁ and 23₃ can also be referred to as lateral straight lines extending from one side of left and right sides of the display surface 4 to the other side.

Furthermore, on the display surface 4, black circle marks 24 and numbers “1”, “2”, “3”, and “4” are displayed at the corners of the target trajectory. By displaying the straight line 23₁ to 23₄, the marks 24, and the numbers “1” to “4”, the display control unit 16 prompts the user to point at the straight line 23₁→the straight line 23₂→the straight line 23₃→the straight line 23₄ in this order along the target trajectory with the specific site 6 (fingertip).

With such a display, the user moves the specific site 6 (fingertip) in the predetermined direction (lateral direction) so as to point at the target trajectory. Examples of the way of moving the specific site 6 (fingertip) include a pattern (hereinafter, also referred to as a “first pattern”) of moving the specific site 6 so as to draw a linear movement trajectory and a pattern (hereinafter, also referred to as a “second pattern”) of moving the specific site 6 so as to draw an arc-shaped movement trajectory about a shoulder and an elbow. In particular, in the case of being used as the drive-through ordering apparatus, that is, in the case where the user extends the arm from the inside of the vehicle and moves the specific site 6 (fingertip), the user tends to move the specific site 6 (fingertip) in the second pattern.

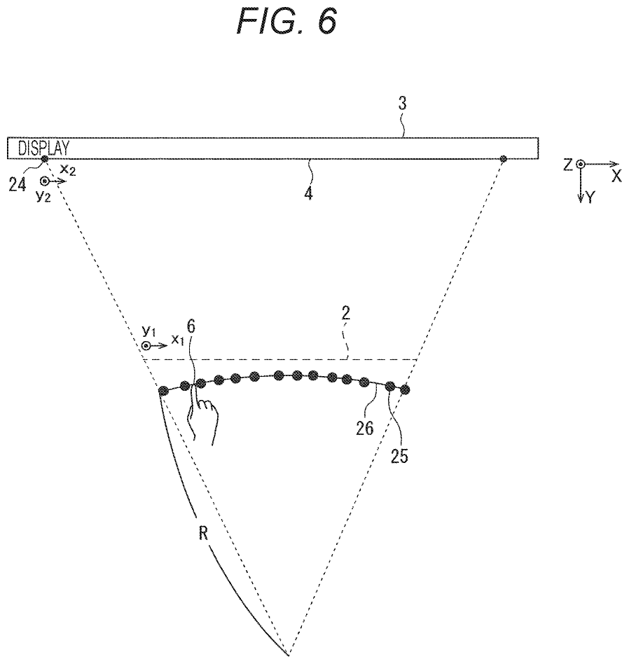

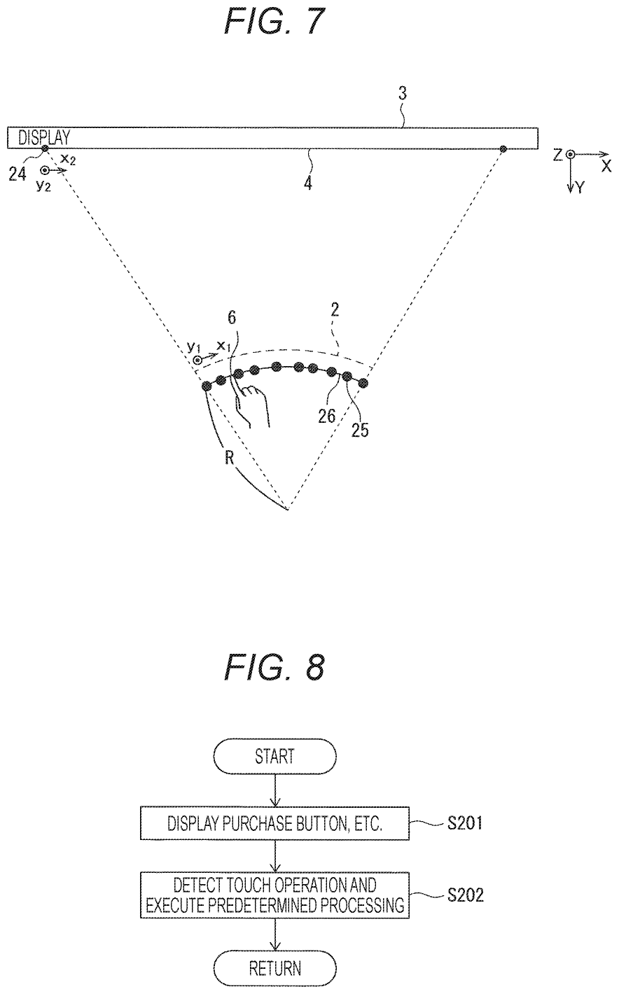

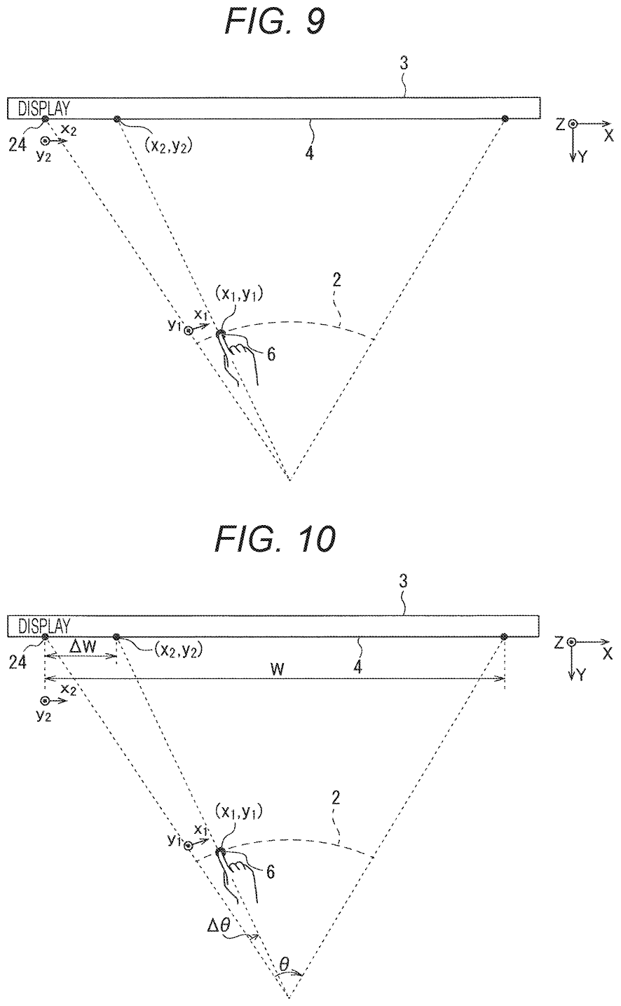

Subsequently, the process proceeds to step S102, and the calculation unit 17 calculates a curvature radius R of the movement trajectory of the specific site 6 (fingertip) when the user moves the specific site 6 (fingertip) in the predetermined direction (lateral direction) on the basis of position information (for example, three-dimensional coordinates) of the specific site 6 (fingertip) of the user. As the three-dimensional coordinates, for example, coordinates (X, Y, Z) of an XYZ coordinate system illustrated in FIG. 1 can be adopted. Specifically, the curvature radius R of the movement trajectory of the specific site 6 (fingertip) when the user points at the target trajectory and moves the specific site 6 (fingertip) is calculated on the basis of the position information (X, Y, Z) of the specific site 6 (fingertip). For example, first, position information (X, Y, Z) of the specific site 6 (fingertip) when the user points at the straight line 23₁ or the straight line 234 along the target trajectory with the specific site 6 (fingertip) is calculated on the basis of the detection result of the TOF sensor 9. Subsequently, position information 25 (for example, two-dimensional coordinates) of the specific site 6 (fingertip) when the specific site 6 (fingertip) is moved in the predetermined direction (lateral direction) in a plan view is calculated on the basis of the calculated position information (X, Y, Z) as illustrated in FIG. 6. As the two-dimensional coordinates, for example, coordinates (X, Y) in which Z of the XYZ coordinate system illustrated in FIG. 1 is omitted can be adopted. Note that FIG. 6 illustrates a case where the specific site 6 (fingertip) is moved in the first pattern, but a case of moving in the second pattern is as illustrated in FIG. 7.

Next, circle fitting for fitting various circles using the least squares method or the Hough transform is performed on the calculated position information 25, and a radius of a circle 26 obtained by the circle fitting is set as the curvature radius R of the movement trajectory of the specific site 6 (fingertip) when the specific site 6 is moved in the predetermined direction (lateral direction). For example, circle fitting may be separately performed on position information of the specific site 6 when the specific site 6 (fingertip) is moved to the right and position information of the specific site 6 when the specific site 6 (fingertip) is moved to the left, and an average value of obtained curvature radii of circles may be set as the curvature radius R.

Subsequently, the process proceeds to step S103, and the calculation unit 17 determines whether or not the curvature radius R calculated in step S102 is larger than a predetermined threshold set in advance. As the predetermined threshold, for example, an average length (for example, 75 cm) from the shoulder to the specific site 6 (fingertip) of the user can be adopted. Then, in a case where it is determined that the curvature radius R is larger than the predetermined threshold (Yes), it is determined that the user has moved the specific site 6 so as to draw the linear movement trajectory (first pattern), it is determined that the flat surface is set as the virtual touch panel surface 2, and the process proceeds to step S104. On the other hand, in a case where it is determined that the curvature radius R is equal to or smaller than the predetermined threshold (No), it is determined that the user has moved the specific site 6 so as to draw the arc-shaped movement trajectory about the shoulder and the elbow (second pattern), it is determined that the curved surface is set as the virtual touch panel surface 2, and the process proceeds to step S105.

In step S104, the setting execution unit 18 sets the flat surface as the virtual touch panel surface 2 as illustrated in FIGS. 1 and 6, and then, ends the calibration process. For example, a vertical plane parallel to the movement trajectory of the specific site 6 (fingertip) used for the calculation of the curvature radius R in step S102, the vertical plane being located slightly (for example, by 2 cm) closer to a side of the display 3 than the movement trajectory is defined as the virtual touch panel surface 2. Furthermore, a left end of the virtual touch panel surface 2 is set on a line segment connecting the specific site 6 (fingertip) and a left end of the straight line 23₁ (lateral straight line) when the user points at the left end of the straight line 23₁ (lateral straight line) illustrated in FIG. 5 with the specific site 6 (fingertip) in the plan view. Similarly, a right end of the virtual touch panel surface 2 is set on a line segment connecting the specific site 6 (fingertip) and a right end of the straight line 23₁ (lateral straight line) when the user points at the right end of the straight line 23₁ (lateral straight line) with the specific site 6 (fingertip) in the plan view. Furthermore, an upper end of the virtual touch panel surface 2 is set on a line segment connecting the specific site 6 (fingertip) and an upper end of the straight line 23₂ (vertical straight line) when the specific site 6 (fingertip) points at the upper end of the straight line 23₂ (vertical straight line) in side view. Furthermore, a lower end of the virtual touch panel surface 2 is set on a line segment connecting the specific site 6 (fingertip) and a lower end of the straight line 23₂ (vertical straight line) when the user points at the lower end of the straight line 23₂ (vertical straight line) with the specific site 6 (fingertip) in side view.

Therefore, in a case where the way of moving the specific site 6 (fingertip) of the user is the first pattern of moving the specific site 6 (fingertip) so as to draw the linear movement trajectory, the setting execution unit 18 can set the virtual touch panel surface 2 having a vertical planar shape (flat surface shape) parallel to the movement trajectory of the specific site 6 (fingertip). Therefore, a distance between the virtual touch panel surface 2 and the specific site 6 (fingertip) immediately before the touch operation on the virtual touch panel surface 2, that is, immediately before an operation of pushing the specific site 6 (fingertip) can be made constant on both a side of a central portion and a side of an end portion of the virtual touch panel surface 2.

On the other hand, in step S105, the setting execution unit 18 sets a curved surface whose central portion is recessed toward the display 3 side as the virtual touch panel surface 2 as illustrated in FIGS. 2 and 7, and then, ends the calibration process. For example, a cylindrical surface concentric with a center of the circle 26 used for the calculation of the curvature radius R in step S102 in the plan view, the cylindrical surface being located slightly (for example, by 2 cm) closer to the side of the display 3 than the circle 26 is set as the virtual touch panel surface 2. That is, the cylindrical surface having an arc shape in the plan view is set as the virtual touch panel surface 2. Note that, as a method of setting a left end, a right end, an upper end, and a lower end of the virtual touch panel surface 2, a method similar to the above-described method of setting the left end, the right end, the upper end, and the lower end of the virtual touch panel surface 2 having the flat surface shape can be adopted.

Therefore, in a case where the way of moving the specific site 6 (fingertip) of the user is the second pattern of moving the specific site 6 (fingertip) so as to draw the arc-shaped movement trajectory about the shoulder and the elbow, the setting execution unit 18 can set the virtual touch panel surface 2 having the curved surface shape whose central portion is recessed to the display 3 side. Therefore, a distance between the virtual touch panel surface 2 and the specific site 6 (fingertip) immediately before the touch operation on the virtual touch panel surface 2, that is, immediately before an operation of pushing the specific site 6 (fingertip) can be made constant on both a side of a central portion and a side of an end portion of the virtual touch panel surface 2.

### 1-3 Content of Ordering Process

Next, the ordering process executed by the display control unit 20, the processing execution unit 21, and the operation detection unit 22, which are achieved by the processor 11, will be described. The ordering process is executed when the calibration process is completed. That is, the ordering process is executed after setting the virtual touch panel surface 2 having the flat surface shape or the curved surface shape.

As illustrated in FIG. 8, in step S201, the display control unit 20 first causes the display surface 4 of the display 3 to display the purchase buttons 7 and the like of the products including the hamburger, the fried potatoes, the drink, and the like as illustrated in FIG. 1 or 2. The display control unit 20 prompts the user to perform an operation for pressing the purchase button 7 by displaying the purchase buttons 7 of the products.

With such a display, the user moves the specific site 6 (fingertip) so as to point at the desired purchase button 7, and performs the operation of pushing the specific site 6 (fingertip) such that the specific site 6 (fingertip) touches the virtual touch panel surface 2 set in the calibration process.

Subsequently, the process proceeds to step S202, and the operation detection unit 22 detects the touch operation on the virtual touch panel surface 2 performed by the user on the basis of position information (X, Y, Z) of the specific site 6 (fingertip) of the user. Specifically, position information (for example, two-dimensional coordinates) of the specific site 6 (fingertip) on the virtual touch panel surface 2 when the touch operation has been performed is calculated, and the calculated position information is converted into position information (for example, two-dimensional coordinates) on the display surface 4. As the position information (two-dimensional coordinates) on the virtual touch panel surface 2, for example, coordinates (x₁, y₁) in an x₁y₁ coordinate system illustrated in FIG. 1 can be adopted. Furthermore, as the position information (two-dimensional coordinates) on the display surface 4, for example, coordinates (x₂, y₂) of an x₂y₂ coordinate system illustrated in FIG. 1 can be adopted.

For example, first, position information (X, Y, Z) of the specific site 6 (fingertip) is calculated on the basis of a detection result of the TOF sensor 9. Subsequently, it is determined whether the touch operation on the virtual touch panel surface 2 set in the calibration process, that is, the operation of touching the virtual touch panel surface 2 with the specific site 6 (fingertip) has been performed on the basis of the calculated position information (X, Y, Z). Then, in a case where it is determined that the touch operation on the virtual touch panel surface 2 has been performed, position information (x₁, y₁) of the specific site 6 (fingertip) on the virtual touch panel surface 2 is calculated on the basis of the position information (X, Y, Z) of the specific site 6 (fingertip) calculated from the detection result of the TOF sensor 9. Subsequently, the calculated position information (x₁, y₁) of the specific site 6 (fingertip) is converted into position information (x₂, y₂) on the display surface 4 of the display 3. As a conversion method, it is possible to adopt a method of using an intersection between a straight line passing through the center of the circle 26 and the specific site 6 (fingertip) in the plan view and the display surface 4 as the position information (x₂, y₂) on the display surface 4 of the display 3, for example, as illustrated in FIG. 7.

Subsequently, the processing execution unit 21 executes processing corresponding to the touch operation detected by the operation detection unit 22. Specifically, processing corresponding to an object (for example, the purchase button 7) displayed at a position indicated by the position information (x₁, y₁) on the display surface 4 of the display 3 converted by the operation detection unit 22 is executed. For example, in a case where it is determined that the purchase button 7 is displayed at the position on the display surface 4 indicated by the position information (x₁, y₁), various types of processing (for example, processing of notifying a clerk or the like that a product has been ordered) in a case where the purchase button 7 is pressed may be executed.

These flows performed by the operation detection unit 22 and the processing execution unit 21 are sequentially repeated until an input operation (for example, pressing an end button) for ending the ordering process is performed.

Through the calibration process and the ordering process, the user can perform the touch operation of touching the virtual touch panel surface 2 with the specific site 6 and order a desired product.

As described above, the curvature radius R of the movement trajectory of the specific site 6 (fingertip) when the user moves the specific site 6 (fingertip) in the predetermined direction (lateral direction) is calculated on the basis of the position information (X, Y, Z) of the specific site 6 (fingertip) of the user in the information processing apparatus 1 and the information processing method according to the first embodiment. Then, the flat surface is set as the virtual touch panel surface 2 in the case where it is determined that the calculated curvature radius R is larger than the predetermined threshold, and the curved surface whose central portion is recessed to the display 3 side is set as the virtual touch panel surface 2 in the case where it is determined that the curvature radius R is equal to or smaller than the predetermined threshold. Therefore, the virtual touch panel surface 2 having the curved surface shape can be set, for example, in the case where the user moves the fingertip so as to draw the arc-shaped movement trajectory about the shoulder or the elbow. Therefore, the distance between the virtual touch panel surface 2 and the specific site 6 (fingertip) immediately before the touch operation on the virtual touch panel surface 2, that is, immediately before the pushing operation with the specific site 6 (fingertip) can be made constant on both the central portion side and the end portion side of the virtual touch panel surface 2. As a result, it is possible to provide the information processing apparatus 1 and the information processing method capable of making the distance for pushing the specific site 6 (fingertip) constant during the touch operation on the virtual touch panel surface 2 and further improving operability.

### 1-4 Modified Examples

(1) Note that the example in which the operation detection unit 22 calculates the position information (x₁, y₁) of the specific site 6 (fingertip) on the virtual touch panel surface 2 on the basis of the position information (X, Y, Z) of the specific site 6 (fingertip) in the XYZ coordinate system, and converts the calculated position information (x₁, y₁) into the position information (x₂, y₂) on the display surface 4 has been described in the first embodiment, but another configuration can also be adopted. A configuration may be adopted in which a rotation angle θ is converted into position information x₂ in the lateral direction such that a ratio of a change amount ΔW of position information x₂ in the lateral direction on the display surface 4 to a change amount Δθ of the rotation angle θ around a center of a line segment connecting the center of the circle 26 obtained by circle fitting and the specific site 6 (fingertip) in the plan view becomes constant in a case where a curved surface whose central portion is recessed to the display 3 side is set as the virtual touch panel surface 2, for example, as illustrated in FIG. 10. The ratio of the change amount ΔW to the change amount Δθ is expressed by the following (1) in a case where a lateral width of the display surface 4 is W.

ΔW/Δθ=2·π·R·W/360 (1)

Here, even in the case where the virtual touch panel surface 2 having the curved surface shape is set, for example, as illustrated in FIG. 7, on the end portion side of the display surface 4, a change amount (ΔW) of position information x₂ in the lateral direction on the display surface 4 to a movement amount (Δθ) of the specific site 6 increases so that the operability decreases in the method of using the intersection of the straight line passing through the center of the circle 26 obtained by circle fitting and the specific site 6 (fingertip) in the plan view and the display surface 4 as the lateral position information x₂ on the display surface 4.

On the other hand, according to the information processing apparatus 1 of the present modified example, the change amount (ΔW) of the position information x₂ in the lateral direction on the display surface 4 to the movement amount (Δθ) of the specific site 6 can be made constant on both the central portion side and the end portion side of the virtual touch panel surface 2, and the operability can be further improved.

(2) Furthermore, the example in which the lateral straight lines (23₁ and 23₃ in FIG. 5) extending from one side of the left and right sides of the display surface 4 to the other side are set as the “straight lines extending in the predetermined direction” has been described in the first embodiment, but another configuration can also be adopted. For example, a configuration may be adopted in which longitudinal straight lines (23₂ and 23₄) extending from one side of upper and lower sides of the display surface 4 to the other side are set as “straight lines extending in predetermined directions” in addition to the lateral straight line. That is, it is configured such that a target trajectory includes lateral straight lines and longitudinal straight lines.

In this case, the calculation unit 17 is configured to calculate not only a curvature radius R₁ (curvature radius in the plan view) of a movement trajectory of the specific site 6 (fingertip) in a case where the user moves the specific site 6 (fingertip) in the lateral direction but also a curvature radius R₂ (curvature radius in side view) of a movement trajectory of the specific site 6 (fingertip) in a case where the user moves the specific site 6 (fingertip) in the longitudinal direction on the basis of position information (X, Y, Z) of the specific site 6 (fingertip).

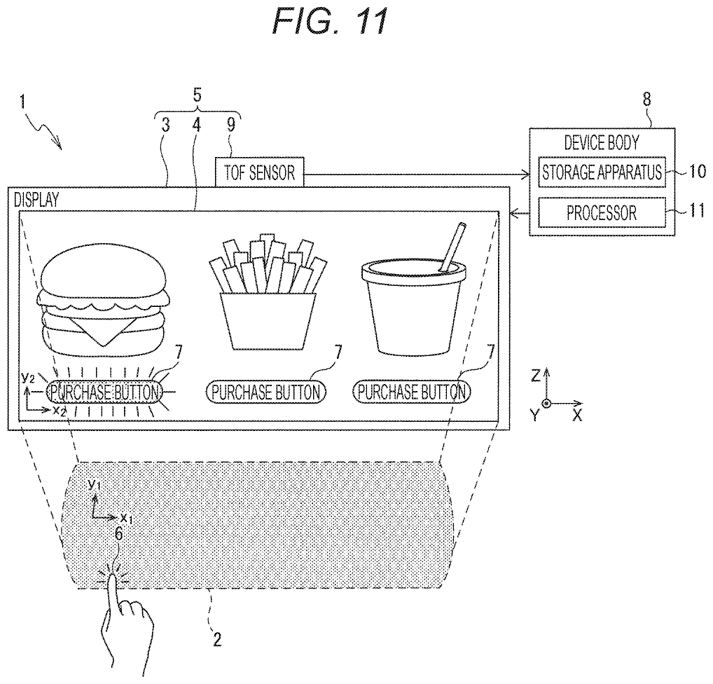

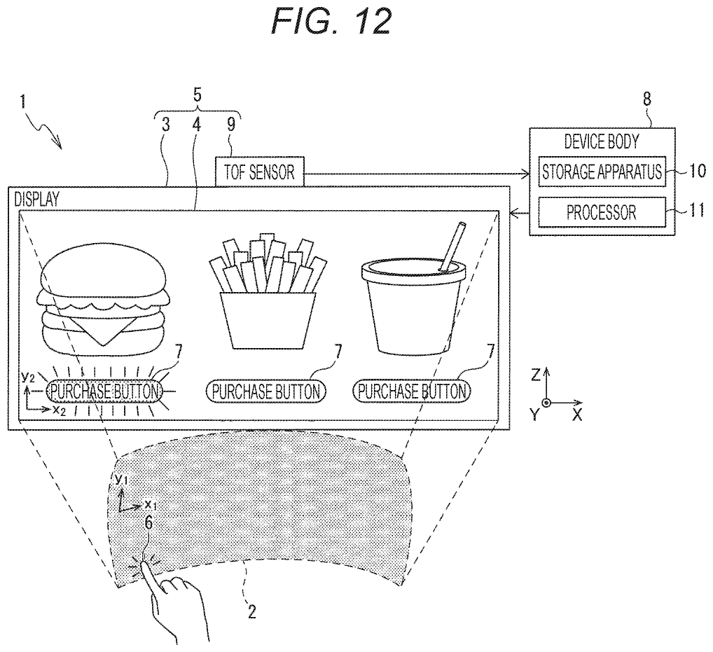

Furthermore, the setting execution unit 18 is configured to set the flat surface as the virtual touch panel surface 2 as illustrated in FIG. 1 in a case where it is determined that the curvature radii R₁ and R₂ calculated by the calculation unit 17 are larger than a predetermined threshold (R₁ and R₂>predetermined threshold). Similarly, it is configured such that the arc-shaped cylindrical surface is set as the virtual touch panel surface 2 in the plan view as illustrated in FIG. 2 in a case where it is determined that R₁≤the predetermined threshold and R₂>the predetermined threshold. Furthermore, it is configured such that an arc-shaped cylindrical surface is set as the virtual touch panel surface 2 in a side view as illustrated in FIG. 11 in a case where it is determined that R₁>the predetermined threshold and R₂≤the predetermined threshold. Furthermore, a bowl-shaped curved surface is set as the virtual touch panel surface 2 as illustrated in FIG. 12 in a case where it is determined that R₁ and R₂≤the predetermined threshold.

### 2. SECOND EMBODIMENT

### 2-1 Configuration of Main Part

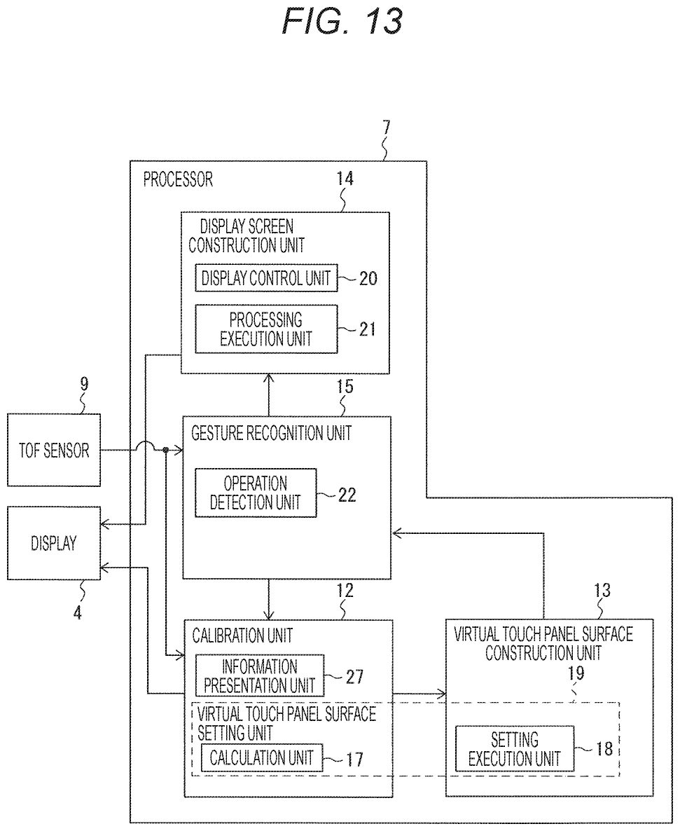

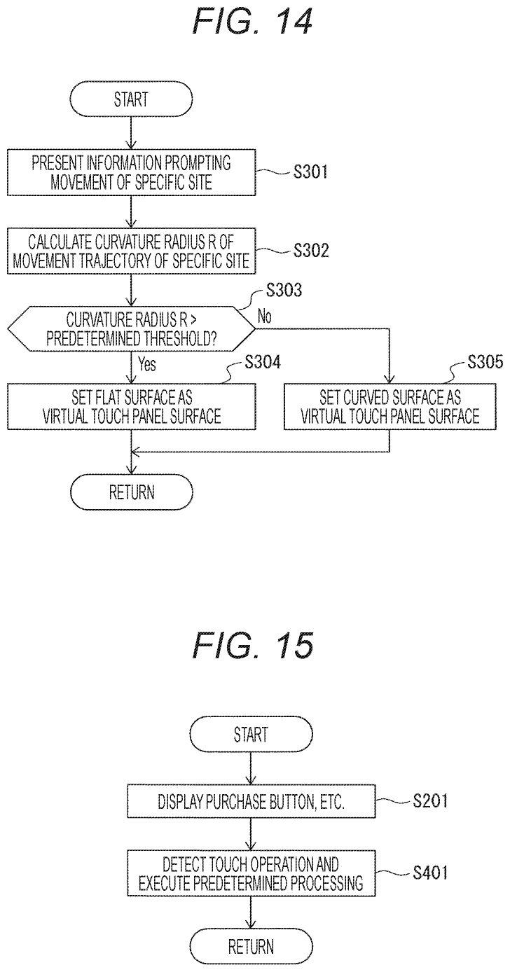

Next, the information processing apparatus 1 and an information processing method according to a second embodiment of the present disclosure will be described. An overall configuration of the information processing apparatus 1 of the second embodiment is similar to that in FIG. 1, and thus, the illustration thereof is omitted. FIG. 13 is a diagram illustrating the calibration unit 12 and the like achieved by the processor 11 of the information processing apparatus 1 according to the second embodiment. FIG. 14 is a flowchart of a calibration process. FIG. 15 is a flowchart of an ordering process. In FIGS. 13, 14, and 15, portions corresponding to those in FIGS. 3, 4, and 8 are denoted by the same reference signs, and the redundant description thereof is omitted.

The information processing apparatus 1 according to the second embodiment is different from that of the first embodiment in terms of a method of setting the virtual touch panel surface 2. Specifically, the processor 11 achieves an information presentation unit 27 illustrated in FIG. 13 instead of the display control unit 16 illustrated in FIG. 3, and executes a calibration process (steps S301, S302, S303, S304, and S305) illustrated in FIG. 14 using the information presentation unit 27, the calculation unit 17, and the setting execution unit 18. Furthermore, the processor 11 executes step S404 illustrated in FIG. 15 instead of step S202 in the ordering process illustrated in FIG. 8 using the display control unit 20, the processing execution unit 21, and the operation detection unit 22 illustrated in FIG. 13.

In the calibration process, in step S301, the information presentation unit 27 first presents prompting information prompting a user to point from one side of left and right sides of a region in which the virtual touch panel surface 2 is desired to be set to the other side with the specific site 6 (fingertip) as illustrated in FIG. 14. As a method of presenting the prompting information, for example, a method of displaying a message on the display 3 can be adopted.

The presentation of the information allows the user to move the specific site 6 (fingertip) in the lateral direction so as to point from one side of the left and right sides of the region in which the virtual touch panel surface 2 is desired to be set to the other side.

Subsequently, the process proceeds to step S302, and the calculation unit 17 calculates a curvature radius R of a movement trajectory of the specific site 6 (fingertip) when the user has been prompted by the prompting information presented in step S301 and moved the specific site 6 (fingertip) in the lateral direction. For example, first, position information (X, Y, Z) of the specific site 6 (fingertip) when the user has moved the specific site 6 (fingertip) in the lateral direction after the presentation of the information in step S101 is calculated on the basis of a detection result of the TOF sensor 9. Subsequently, position information 25 (X, Y) of the specific site 6 (fingertip) when the specific site 6 (fingertip) has been moved in the predetermined direction (lateral direction) in a plan view is calculated on the basis of the calculated position information (X, Y, Z) as illustrated in FIG. 15A. Next, circle fitting for fitting various circles to the calculated position information 25 (X, Y) is performed, and a radius of the circle 26 obtained by the circle fitting is set as the curvature radius R of the movement trajectory of the specific site 6 (fingertip) when the specific site 6 has been moved in the lateral direction. Note that FIG. 15A illustrates a case where the specific site 6 (fingertip) is moved in the first pattern, and a case where the specific site 6 (fingertip) is moved in the second pattern is illustrated in FIG. 15B.

Subsequently, the process proceeds to step S303, and the calculation unit 17 determines whether or not the curvature radius R calculated in step S302 is larger than a predetermined threshold set in advance. Then, in a case where it is determined that the curvature radius R is larger than the predetermined threshold (Yes), the process proceeds to step S304. On the other hand, in a case where it is determined that the curvature radius R is equal to or smaller than the predetermined threshold (No), the process proceeds to step S305.

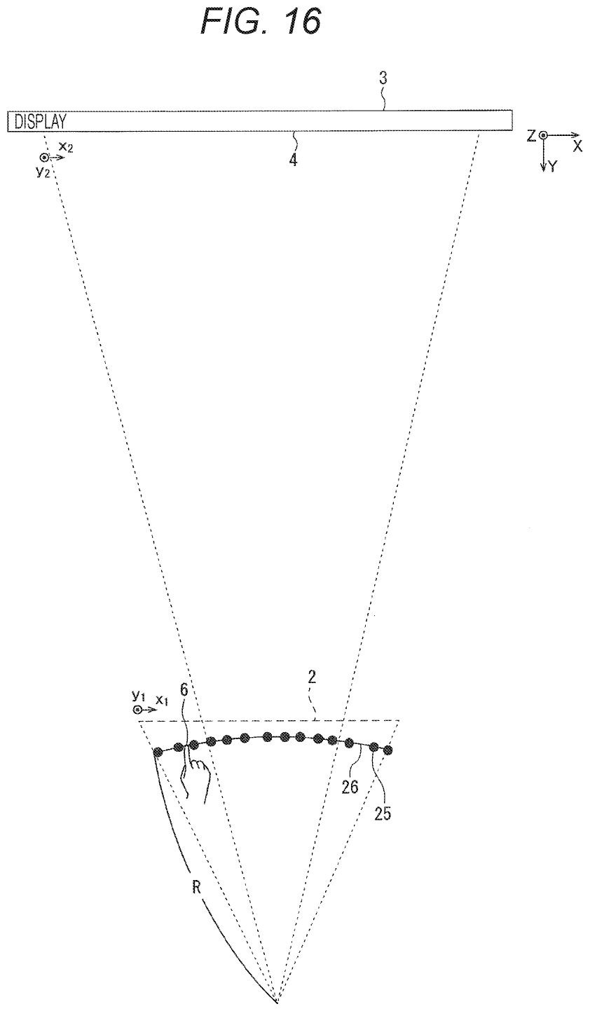

In step S304, the setting execution unit 18 sets a flat surface as the virtual touch panel surface 2 as illustrated in FIGS. 1 and 16, and then, ends the calibration process. For example, a vertical plane parallel to the movement trajectory of the specific site 6 (fingertip) used for the calculation of the curvature radius R in step S302, the vertical plane being located slightly (for example, by 2 cm) closer to a side of the display 3 than the movement trajectory is defined as the virtual touch panel surface 2. Furthermore, a left end of the virtual touch panel surface 2 is set to a position pointed at by the specific site 6 (fingertip) when the specific site 6 (fingertip) is located at a left end of the movement trajectory in the plan view. For example, in a case where the specific site 6 is a fingertip, a position existing on a straight line passing through the fingertip and an elbow of the user and separated from the fingertip to the display 3 side by a predetermined distance (for example, 2 cm) can be adopted as the position pointed at by the specific site 6 (fingertip). Similarly, a right end of the virtual touch panel surface 2 is set to a position pointed at by the specific site 6 (fingertip) when the specific site 6 (fingertip) is located at a right end of the movement trajectory in the plan view.

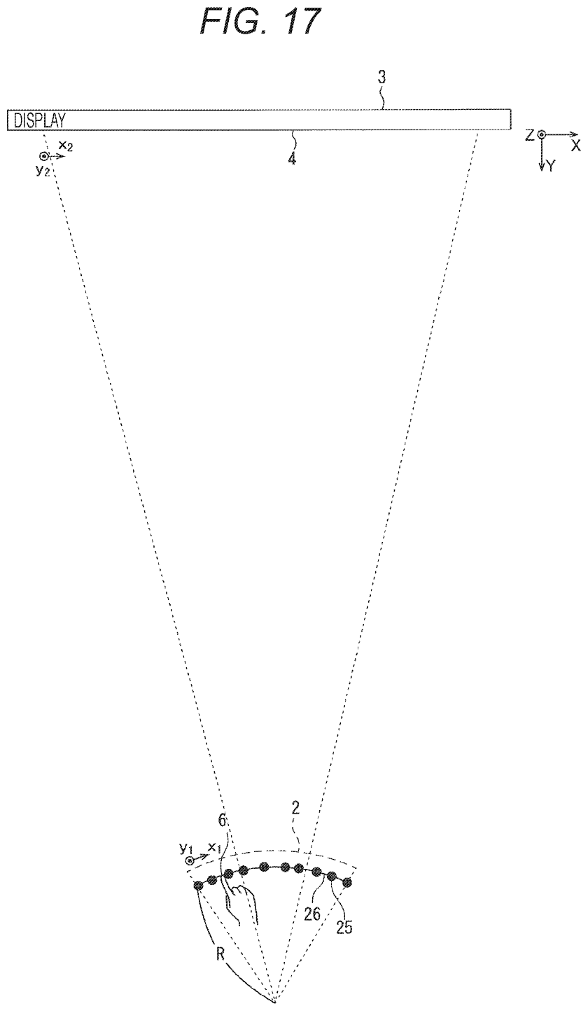

On the other hand, in step S305, the setting execution unit 18 sets a curved surface whose central portion is recessed toward the display 3 side as the virtual touch panel surface 2 as illustrated in FIGS. 2 and 17, and then, ends the calibration process. For example, a cylindrical surface concentric with a center of the circle 26 used for the calculation of the curvature radius R in step S302 in the plan view, the cylindrical surface being located slightly (for example, by 2 cm) closer to the side of the display 3 than the circle 26 is set as the virtual touch panel surface 2. That is, the cylindrical surface having an arc shape in the plan view is set as the virtual touch panel surface 2. Note that, as a method of setting a left end and a right end of the virtual touch panel surface 2, a method similar to the above-described method of setting the left end and the right end of the virtual touch panel surface 2 having the flat surface shape can be adopted.

Furthermore, in step S401, the operation detection unit 22 detects a touch operation on the virtual touch panel surface 2 performed by the user on the basis of position information (X, Y, Z) of the specific site 6 (fingertip) of the user. For example, first, the position information (X, Y, Z) of the specific site 6 (fingertip) of the user is calculated on the basis of a detection result of the TOF sensor 9. Subsequently, it is determined whether the touch operation on the virtual touch panel surface 2 set in the calibration process has been performed on the basis of the calculated position information (X, Y, Z). Then, in a case where it is determined that the touch operation has been performed, position information (x₂, y₂) on the display surface 4 is calculated on the basis of the position information (X, Y, Z) of the specific site 6 (fingertip).

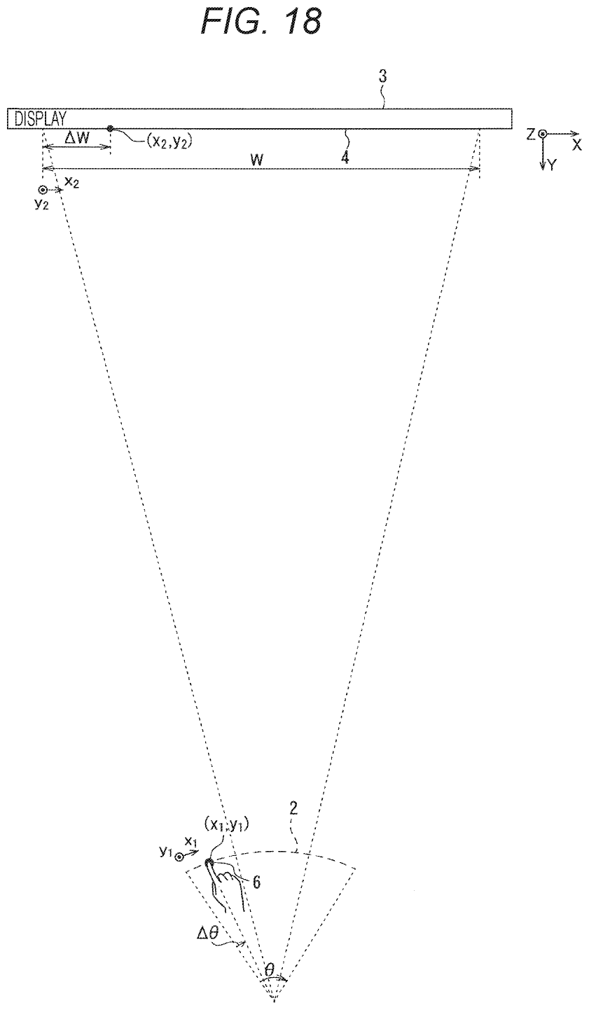

Here, in a case where the flat surface is set as the virtual touch panel surface 2 in the calibration process, position information (x₁, y₁) of the specific site 6 (fingertip) on the virtual touch panel surface 2 is calculated, and the calculated position information (x₁, y₁) of the specific site 6 (fingertip) on the virtual touch panel surface 2 is converted into position information (x₂, y₂) on the display surface 4 of the display 3. As a conversion method, for example, a method using a transformation matrix for converting the position information (x₁, y₁) on the virtual touch panel surface 2 into the position information (x₁, y₂) on the display surface 4 can be adopted. On the other hand, in a case where the curved surface is set as the virtual touch panel surface 2, a rotation angle θ is converted into position information x₂ in the lateral direction such that a ratio of a change amount ΔW of position information in the lateral direction on the display surface 4 to a change amount Δθ of the rotation angle θ around a center of a line segment connecting the center of the circle 26 obtained by the circle fitting and the specific site 6 (fingertip) in a plan view becomes constant as illustrated in FIG. 18.

Subsequently, the processing execution unit 21 executes processing corresponding to the touch operation detected by the operation detection unit 22. Specifically, processing corresponding to an object displayed at a position indicated by the position information (x₂, y₂) on the display surface 4 of the display 3 converted by the operation detection unit 22 is executed. For example, in a case where it is determined that the purchase button 7 is displayed at the position on the display surface 4 indicated by the converted position information (x₂, y₂), various types of processing in a case where the purchase button 7 is pressed are executed.

As described above, in the information processing apparatus 1 and the information processing method according to the second embodiment, the prompting information for prompting to point from one side of the left and right sides of the region where the virtual touch panel surface 2 is desired to be set to the other side with the specific site 6 (fingertip) is presented. Then, the curvature radius R of the movement trajectory of the specific site 6 (fingertip) when the user has been prompted by the presented prompting information and moved the specific site 6 (fingertip) in the lateral direction is calculated. Therefore, it is unnecessary to point at a target trajectory with the specific site 6 (fingertip), and the operation to be performed by the user can be simplified, which is different from the method of using, for example, the movement trajectory of the specific site 6 (fingertip) when the specific site 6 (fingertip) has been moved by pointing at the target trajectory for the calculation of the curvature radius R, that is, the method described in the first embodiment.

Here, if a distance between the display 3 and the user is large, for example, in the case of using the method of setting the end (left end or right end) of the virtual touch panel surface 2 on the line segment connecting the specific site 6 (fingertip) at the time of pointing at the end (left end or right end) of the target trajectory and the end (left end, right end) of the target trajectory, there is a possibility that a size of the virtual touch panel surface 2 decreases so that operability deteriorates.

On the other hand, in the information processing apparatus 1 according to the second embodiment, the left end of the virtual touch panel surface 2 is set at the position pointed at by the specific site 6 (fingertip) when the specific site 6 (fingertip) is located at the left end of the movement trajectory. Furthermore, the right end of the virtual touch panel surface 2 is set at the position pointed at by the specific site 6 (fingertip) when the specific site 6 (fingertip) is located at the right end of the movement trajectory. Therefore, the size of the virtual touch panel surface 2 is not limited by a size of the display 3 (display surface 4), the size of the virtual touch panel surface 2 can be enlarged, and the operability can be improved.

Furthermore, in the information processing apparatus 1 and the information processing method according to the second embodiment, the rotation angle θ is converted into the position information in the lateral direction on the display surface 4 such that the ratio of the change amount ΔW of the position information in the lateral direction on the display surface 4 to the change amount Δθ of the rotation angle θ around the center of the line segment connecting the center of the circle 26 obtained by the circle fitting and the specific site 6 (fingertip) in the plan view becomes constant. Therefore, the user can change the position information in the lateral direction on the display surface 4 by changing the rotation angle θ of the specific site 6 (fingertip). Furthermore, the change amount (ΔW) of the position information in the lateral direction on the display surface 4 to a movement amount (Δθ) of the specific site 6 can be made constant on both the central portion side and an end portion side of the virtual touch panel surface 2, and the operability can be further improved.

### 2-2 Modified Examples

(1) Note that, a configuration in which, in the ordering process, position information (X, Y, Z) indicating a position (for example, an intersection between a straight line passing through a fingertip and an elbow of a user and the virtual touch panel surface 2) on the virtual touch panel surface 2 pointed at by the specific site 6 (fingertip) is calculated, and a pointer is displayed on position information (x₂, y₂) on the display surface 4 corresponding to the calculated position information (X, Y, Z) in the ordering process may be adopted in the second embodiment. Therefore, a touch operation can be easily performed.

(2) Furthermore, the example in which the prompting information for prompting to point from one side of the left and right sides of the region where the virtual touch panel surface 2 is desired to be set to the other side is presented with the specific site 6 (fingertip) has been described in the second embodiment, but another configuration may be adopted. For example, it may be configured such that prompting information for prompting to point from one side of upper and lower sides to the other side with the specific site 6 (fingertip) is presented in addition to the prompting information for prompting to point from one side of the left and right sides to the other side with the specific site 6 (fingertip).

In this case, the calculation unit 17 is configured to calculate not only a curvature radius R₁ (curvature radius in the plan view) of a movement trajectory of the specific site 6 (fingertip) in a case where the user moves the specific site 6 (fingertip) in the lateral direction but also a curvature radius R₂ (curvature radius in side view) of a movement trajectory of the specific site 6 (fingertip) in a case where the user moves the specific site 6 (fingertip) in the longitudinal direction on the basis of position information (X, Y, Z) of the specific site 6 (fingertip).

Furthermore, the setting execution unit 18 is configured to set the flat surface as the virtual touch panel surface 2 as illustrated in FIG. 1 in a case where it is determined that the curvature radii R₁ and R₂ calculated by the calculation unit 17 are larger than a predetermined threshold (R₁ and R₂>predetermined threshold). Similarly, it is configured such that the arc-shaped cylindrical surface is set as the virtual touch panel surface 2 in the plan view as illustrated in FIG. 2 in a case where it is determined that R₁≤the predetermined threshold and R₂>the predetermined threshold. Furthermore, it is configured such that an arc-shaped cylindrical surface is set as the virtual touch panel surface 2 in a side view as illustrated in FIG. 11 in a case where it is determined that R₁>the predetermined threshold and R₂≤the predetermined threshold. Furthermore, a bowl-shaped curved surface is set as the virtual touch panel surface 2 as illustrated in FIG. 12 in a case where it is determined that R₁ and R₂≤the predetermined threshold.

Furthermore, the present disclosure may be configured to include the following technical matters.

(1)

An information processing apparatus including:
a virtual touch panel surface setting unit that sets a virtual touch panel surface, which does not actually exist, in a space in front of a display surface of a display;
an operation detection unit that detects a touch operation on the virtual touch panel surface performed by a user on the basis of position information of a specific site of a body used by the user for the touch operation on the virtual touch panel surface; and
a processing execution unit that executes processing corresponding to the touch operation detected by the operation detection unit,
in which the virtual touch panel surface setting unit includes
a calculation unit that calculates a curvature radius of a movement trajectory of the specific site when the user has moved the specific site in a predetermined direction on the basis of the position information of the specific site, and
a setting execution unit that sets a flat surface as the virtual touch panel surface in a case where it is determined that the curvature radius calculated by the calculation unit is larger than a predetermined threshold, and sets a curved surface whose central portion is recessed to a side of the display as the virtual touch panel surface in a case where it is determined that the curvature radius calculated by the calculation unit is equal to or smaller than the predetermined threshold.

(2)

The information processing apparatus according to (1), further including
a display control unit that displays a target trajectory including a straight line extending in the predetermined direction on the display surface,
in which the calculation unit calculates a curvature radius of a movement trajectory of the specific site when the user has moved the specific site by pointing at the target trajectory on the basis of the position information of the specific site.

(3)

The information processing apparatus according to (2), in which
the target trajectory includes a lateral straight line extending from one side of left and right sides of the display surface to another side.

(4)

The information processing apparatus according to (3), in which
the setting execution unit
sets a left end of the virtual touch panel surface on a line segment connecting the specific site when pointing at a left end of the lateral straight line and the left end of the lateral straight line, and
sets a right end of the virtual touch panel surface on a line segment connecting the specific site when pointing at a right end of the lateral straight line and the right end of the lateral straight line.

(5)

The information processing apparatus according to (4), in which
the operation detection unit calculates position information of the specific site on the virtual touch panel surface and converts the calculated position information into position information on the display surface, and
the processing execution unit executes processing corresponding to an object displayed at a position indicated by the position information converted by the operation detection unit.

(6)

The information processing apparatus according to (4), in which
the calculation unit calculates position information of the specific site when pointing at the lateral straight line in a plan view, performs circle fitting on the calculated position information, and sets a radius of a circle obtained by the circle fitting as the curvature radius of the movement trajectory,
in a case where the curved surface is set as the virtual touch panel surface, the operation detection unit converts a rotation angle into position information in a lateral direction such that a ratio of a change amount of position information in the lateral direction on the display surface to a change amount of the rotation angle around a center of a line segment connecting the center of the circle obtained by the circle fitting and the specific site in the plan view becomes constant, and
the processing execution unit executes processing corresponding to an object displayed at a position indicated by the position information converted by the operation detection unit.

(7)

The information processing apparatus according to (2), in which
the target trajectory includes a lateral straight line extending from one side of left and right sides of the display surface to another side and a longitudinal straight line extending from one side of upper and lower sides of the display surface to another side.

(8)

The information processing apparatus according to (1), further including
an information presentation unit that presents prompting information for prompting to point from one side of left and right sides of a region in which the virtual touch panel surface is desired to be set to another side with the specific site,
in which the calculation unit calculates a curvature radius of a movement trajectory of the specific site when the user has been prompted by the prompting information presented by the information presentation unit and moved the specific site in a lateral direction.

(9)

The information processing apparatus according to (8), in which
the setting execution unit
sets a left end of the virtual touch panel surface at a position pointed at by the specific site when the specific site is located at a left end of the movement trajectory, and
sets a right end of the virtual touch panel surface at a position pointed at by the specific site when the specific site is located at a right end of the movement trajectory.

(10)

The information processing apparatus according to (9), in which
the calculation unit calculates position information of the specific site when the specific site has been moved in the lateral direction in a plan view after the presentation of the information, performs circle fitting on the calculated position information, and sets a radius of a circle obtained by the circle fitting as the curvature radius of the movement trajectory,
in a case where the curved surface is set as the virtual touch panel surface, the operation detection unit converts a rotation angle into position information in a lateral direction such that a ratio of a change amount of position information in the lateral direction on the display surface to a change amount of the rotation angle around a center of a line segment connecting the center of the circle obtained by the circle fitting and the specific site in the plan view becomes constant, and
the processing execution unit executes processing corresponding to an object displayed at a position indicated by the position information converted by the operation detection unit.

(11)

An information processing method including:
setting a virtual touch panel surface, which does not actually exist, in a space in front of a display surface of a display;
detecting a touch operation on the virtual touch panel surface performed by a user on the basis of position information of a specific site of a body used by the user for the touch operation on the virtual touch panel surface; and
executing processing corresponding to the touch operation detected in the operation detection unit,
in which the setting of the virtual touch panel surface includes
calculating a curvature radius of a movement trajectory of the specific site when the user has moved the specific site in a predetermined direction on the basis of the position information of the specific site, and
setting a flat surface as the virtual touch panel surface in a case where it is determined that the curvature radius calculated in the calculation unit is larger than a predetermined threshold, and setting a curved surface whose central portion is recessed to a side of the display as the virtual touch panel surface in a case where it is determined that the curvature radius calculated in the calculation unit is equal to or smaller than the predetermined threshold.

### REFERENCE SIGNS LIST

1 Information processing apparatus
2 Virtual touch panel surface
3 Display
4 Display surface
5 User interface
6 Specific site
7 Purchase button
8 Device body
9 Information acquisition unit (TOF sensor)
10 Storage apparatus
11 Processor
12 Calibration unit
13 Virtual touch panel surface construction unit
14 Display surface construction unit
15 Gesture recognition unit
16 Display control unit
17 Calculation unit
18 Setting execution unit
19 Virtual touch panel surface setting unit
20 Display control unit
21 Processing execution unit
22 Operation detection unit
24 Mark
25 Position information
26 Circle
27 Information presentation unit

1. An information processing apparatus comprising:
a virtual touch panel surface setting unit that sets a virtual touch panel surface, which does not actually exist, in a space in front of a display surface of a display;
an operation detection unit that detects a touch operation on the virtual touch panel surface performed by a user on a basis of position information of a specific site of a body used by the user for the touch operation on the virtual touch panel surface; and
a processing execution unit that executes processing corresponding to the touch operation detected by the operation detection unit,
wherein the virtual touch panel surface setting unit includes
a calculation unit that calculates a curvature radius of a movement trajectory of the specific site when the user has moved the specific site in a predetermined direction on a basis of the position information of the specific site, and
a setting execution unit that sets a flat surface as the virtual touch panel surface in a case where it is determined that the curvature radius calculated by the calculation unit is larger than a predetermined threshold, and sets a curved surface whose central portion is recessed to a side of the display as the virtual touch panel surface in a case where it is determined that the curvature radius calculated by the calculation unit is equal to or smaller than the predetermined threshold.

2. The information processing apparatus according to claim 1, further comprising
a display control unit that displays a target trajectory including a straight line extending in the predetermined direction on the display surface,
wherein the calculation unit calculates a curvature radius of a movement trajectory of the specific site when the user has moved the specific site by pointing at the target trajectory on a basis of the position information of the specific site.

3. The information processing apparatus according to claim 2, wherein
the target trajectory includes a lateral straight line extending from one side of left and right sides of the display surface to another side.

4. The information processing apparatus according to claim 3, wherein
the setting execution unit
sets a left end of the virtual touch panel surface on a line segment connecting the specific site when pointing at a left end of the lateral straight line and the left end of the lateral straight line, and
sets a right end of the virtual touch panel surface on a line segment connecting the specific site when pointing at a right end of the lateral straight line and the right end of the lateral straight line.

5. The information processing apparatus according to claim 4, wherein
the operation detection unit calculates position information of the specific site on the virtual touch panel surface and converts the calculated position information into position information on the display surface, and
the processing execution unit executes processing corresponding to an object displayed at a position indicated by the position information converted by the operation detection unit.

6. The information processing apparatus according to claim 4, wherein
the calculation unit calculates position information of the specific site when pointing at the lateral straight line in a plan view, performs circle fitting on the calculated position information, and sets a radius of a circle obtained by the circle fitting as the curvature radius of the movement trajectory,
in a case where the curved surface is set as the virtual touch panel surface, the operation detection unit converts a rotation angle into position information in a lateral direction such that a ratio of a change amount of position information in the lateral direction on the display surface to a change amount of the rotation angle around a center of a line segment connecting the center of the circle obtained by the circle fitting and the specific site in the plan view becomes constant, and
the processing execution unit executes processing corresponding to an object displayed at a position indicated by the position information converted by the operation detection unit.

7. The information processing apparatus according to claim 2, wherein
the target trajectory includes a lateral straight line extending from one side of left and right sides of the display surface to another side and a longitudinal straight line extending from one side of upper and lower sides of the display surface to another side.

8. The information processing apparatus according to claim 1, further comprising
an information presentation unit that presents prompting information for prompting to point from one side of left and right sides of a region in which the virtual touch panel surface is desired to be set to another side with the specific site,
wherein the calculation unit calculates a curvature radius of a movement trajectory of the specific site when the user has been prompted by the prompting information presented by the information presentation unit and moved the specific site in a lateral direction.

9. The information processing apparatus according to claim 8, wherein
the setting execution unit
sets a left end of the virtual touch panel surface at a position pointed at by the specific site when the specific site is located at a left end of the movement trajectory, and
sets a right end of the virtual touch panel surface at a position pointed at by the specific site when the specific site is located at a right end of the movement trajectory.

10. The information processing apparatus according to claim 9, wherein
the calculation unit calculates position information of the specific site when the specific site has been moved in the lateral direction in a plan view after the presentation of the information, performs circle fitting on the calculated position information, and sets a radius of a circle obtained by the circle fitting as the curvature radius of the movement trajectory,
in a case where the curved surface is set as the virtual touch panel surface, the operation detection unit converts a rotation angle into position information in a lateral direction such that a ratio of a change amount of position information in the lateral direction on the display surface to a change amount of the rotation angle around a center of a line segment connecting the center of the circle obtained by the circle fitting and the specific site in the plan view becomes constant, and
the processing execution unit executes processing corresponding to an object displayed at a position indicated by the position information converted by the operation detection unit.

11. An information processing method comprising:
setting a virtual touch panel surface, which does not actually exist, in a space in front of a display surface of a display;
detecting a touch operation on the virtual touch panel surface performed by a user on a basis of position information of a specific site of a body used by the user for the touch operation on the virtual touch panel surface; and
executing processing corresponding to the detected touch operation,
wherein the setting of the virtual touch panel surface includes
calculating a curvature radius of a movement trajectory of the specific site when the user has moved the specific site in a predetermined direction on a basis of the position information of the specific site, and
setting a flat surface as the virtual touch panel surface in a case where it is determined that the calculated curvature radius is larger than a predetermined threshold, and setting a curved surface whose central portion is recessed to a side of the display as the virtual touch panel surface in a case where it is determined that the calculated curvature radius is equal to or smaller than the predetermined threshold.
